(19) United States
(12) Patent Application Publication
(10) Pub. No.: US 2016/0216672 A1
(43) Pub. Date: Jul. 28, 2016

(54) PRINTING DEVICE, SUPPLY DEVICE, ROLLER CONTROL METHOD AND PROGRAM

(71) Applicant: CASIO COMPUTER CO., LTD., Shibuya-ku, Tokyo (JP)

(72) Inventors: Toshihiko NUMAZU, Sayama-shi, Saitama (JP); Toshio NAGASAKA, Iruma-shi, Saitama (JP); Toshiaki YAJIMA, Iruma-shi, Saitama (JP)

(73) Assignee: CASIO COMPUTER CO., LTD., Shibuya-ku, Tokyo (JP)

(21) Appl. No.: 14/917,260

(22) PCT Filed: Sep. 5, 2014
(86) PCT No.: PCT/JP2014/073545

§ 371 Date: Mar. 7, 2016

(30) Foreign Application Priority Data
Sep. 12, 2013 (JP) 2013-189713

(51) Int. Cl. G03G 15/00

(52) U.S. Cl. CPC G03G 15/6523

(57) ABSTRACT

A printing device includes an image former performing an image formation on a recording medium in a rolled shape, and including a first roller pair that rotates to convey the recording medium in the rolled shape, and, a supplier including a second roller pair that rotates to convey the wound-off recording medium in the rolled shape to the image former, and a controller that actively rotates the second roller pair. The image former includes a determiner that determines whether or not the first roller pair that conveys the recording medium in the rolled shape conveyed from the second roller pair has held the recording medium in the rolled shape. When the determiner determines that the recording medium in the rolled shape has been held, the controller stops the active rotation of the second roller pair.

### TECHNICAL FIELD

The present disclosure relates to a printing device, a supply device, a roller control method, and a program.

### BACKGROUND ART

There are rolled recording media (hereinafter, simply referred to as “roll paper”) which are recording media, such as papers and films, for image formation and which are wound in a rolled shape.

Since rolled papers have a longer image formation time in a single process than those of cut papers, the adverse effect when running obliquely is greater than those of cut papers.

In order to suppress such oblique running, a scheme of conveying a roll paper linearly (that is, a paper feeding device that feeds the roll paper and a printer main box that forms an image on the fed roll paper are disposed on a straight line), and performing printing is popular (see, for example, Patent Literature 1).

### CITATION LIST

### Patent Literature

Patent Literature 1: Unexamined Japanese Patent Application Kokai Publication No. 2008-74051

### SUMMARY OF INVENTION

### Technical Problem

In view of the disposition space, and the like, a scheme of placing and stacking the printer main box on the paper feeding device to perform printing on the roll paper may be practical. According to this scheme, however, since the roll paper needs to be turned for direction upwardly and carried, the roll paper is likely to run obliquely in comparison with the case in which the roll paper is carried linearly.

In addition, in order to enable the printer main box to form a precise image, a conveying speed by rollers in the paper feeding device that feeds the roll paper to the main box is set to be faster than a conveying speed by rollers in the printer main box to form a certain amount of slack in the roll paper. This slack often causes the roll paper to run obliquely.

Still further, correcting the oblique running before the roll paper is fed to the printer main box may be also practical by installing an oblique running detecting sensor or the like in the paper feeding device, and a mechanism (for example, a mechanism with mechanical components like an actuator) when the oblique running is detected. However, this increases the number of components, resulting in the size increase of a paper feeder and the cost increase in manufacturing.

In view of such a circumstance, a conveyance of a roll paper which suppresses an oblique running while reducing a disposition space and avoiding a complicated mechanism.

### Solution to Problem

A printing device according to an aspect of the present disclosure includes:

an image former performing an image formation on a recording medium in a rolled shape, and including a first roller pair that rotates to convey the recording medium in the rolled shape; and

a supplier including a second roller pair that rotates to convey the wound-off recording medium in the rolled shape to the image former, and a controller that actively rotates the second roller pair,

in which:

the image former includes a determiner that determines whether or not the first roller pair that conveys the recording medium in the rolled shape conveyed from the second roller pair has held the recording medium in the rolled shape; and

when the determiner determines that the recording medium in the rolled shape has been held, the controller stops the active rotation of the second roller pair.

A supply device according to another aspect of the present disclosure includes:

a controller that actively rotates a second roller pair which rotates to convey a wound-off recording medium in a rolled shape to an image forming device; and

a determiner that determines whether or not a first roller pair of the image forming device has held the recording medium in the rolled shape, the first roller pair rotating to convey the recording medium in the rolled shape, and the recording medium being conveyed from the second roller pair,

in which when the determiner determines that the recording medium in the rolled shape has been held, the controller stops the active rotation of the second roller pair.

A roller control method according to the other aspect includes:

a controlling step of actively rotating a second roller pair that rotates to convey a wound-off recording medium in a rolled shape to an image forming device; and

a determining step of determining whether or not a first roller pair of the image forming device has held the recording medium in the rolled shape, the first roller pair rotating to convey the recording medium in the rolled shape, and the recording medium being conveyed from the second roller pair,

in which when, in the determining step, the recording medium in the rolled shape is determined as being held by the first roller pair, the active rotation of the second roller pair is stopped.

A program according the further other aspect of the present disclosure causes a computer to function as:

a controller that actively rotates a second roller pair which rotates to convey a wound-off recording medium in a rolled shape to an image forming device; and

a determiner that determines whether or not a first roller pair of the image forming device has held the recording medium in the rolled shape, the first roller pair rotating to convey the recording medium in the rolled shape, and the recording medium being conveyed from the second roller pair,

in which when the determiner determines that the recording medium in the rolled shape has been held, the controller stops the active rotation of the second roller pair.

### BRIEF DESCRIPTION OF DRAWINGS

FIG. 1 is a diagram illustrating a structure of a printing device that includes a paper feeding device and an image forming device according to an embodiment of the present invention;

FIG. 2 is a plan view illustrating a paper feeding device that is being opened;

FIG. 3 is a cross-sectional view illustrating an internal structure of an image forming device;

FIG. 4 is a block diagram with respect to a control of the image forming device;

FIG. 5 is a block diagram with respect to a control of the paper feeding device;

FIG. 6 is a flowchart illustrating a flow of processes executed by the image forming device and by the paper feeding device; and

FIG. 7 is a flowchart illustrating a flow of a cutting process of a roll paper by the paper feeding device.

### DESCRIPTION OF EMBODIMENTS

Further objects and advantages of the present disclosure will be set forth in the description which follows, and in part will be apparent from the description, or may be learned by practice of the present disclosure. The objects and advantages of the present disclosure may be realized and obtained by means of the instrumentalities and combinations particularly pointed out hereinafter.

The accompanying drawings are incorporated in a part of the specification, and constitute a part of the specification to illustrate embodiments of the present disclosure. In addition, the accompanying drawings together with the general description given above and the detailed description of the embodiments given below serve to explain the principles of the present disclosure.

Embodiments of the present disclosure will be described below in detail with reference to the accompanying drawings. Note that components of the same or equivalent functions in the drawings are indicated by the same reference signs.

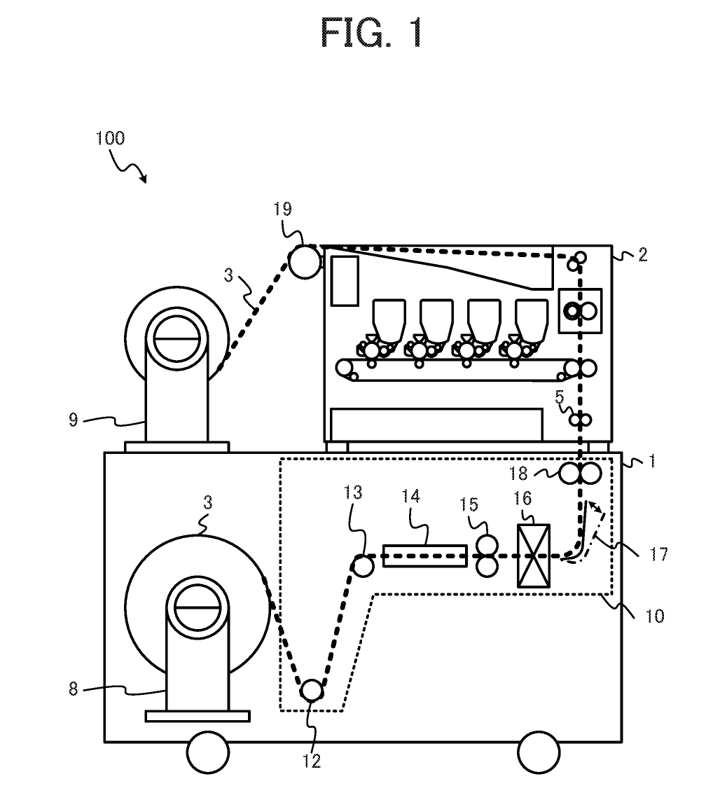

FIG. 1 illustrates a structure of a printing device that includes a paper feeding device and an image forming device according to an embodiment of the present disclosure. Dashed lines in the figure indicate a roll paper 3 that is a recording medium in a rolled shape.

This printing device 100 employs a structure in which an image forming device 2 that forms an image on the roll paper 3 is placed and stacked on a paper feeding device 1 that feeds the roll paper 3. Note that the image forming device 2 and the paper feeding device 1 function as an image former and a supplier, respectively.

The paper feeding device 1 wounds off the roll paper 3 in sequence which is the paper wound around a winding center (a paper tube) in a rolled shape, and conveys the roll paper to the image forming device 2. More specifically, the paper feeding device 1 includes a holder (an unwinder) 8, and a conveyer 10 both provided in the paper feeding device, and further includes a winder (a rewinder) 9 provided above the holder and the conveyer.

The holder 8 is a member to hold the roll paper 3 to be supplied to the image forming device 2. The holder 8 includes a rotatable rotating shaft (a shaft) which passes through the winding center of the roll paper 3, and which holds the roll paper 3, and, a support stage that supports the rotating shaft. The holder rotatably holds the roll paper 3.

The holder 8 is equipped with an unillustrated motor to rotate the rotating shaft. The holder 8 rotates, by driving this motor, the rotating shaft at a number of rotations per an instructed unit time, wounds off the holding roll paper 3, and feeds the roll paper to the conveyer 10.

The conveyer 10 conveys the roll paper 3 by the holder 8 along a conveying route, and supplies the conveyed part to the image forming device 2. More specifically, the conveyer 10 includes a tension roller 12, a follower roller 13, a paper setup unit 14, a paper-feeder conveying roller pair 15 (third roller pair), a guillotine cutter 16, a turnover guide 17, and a main-box-entry conveying roller pair (second roller pair) 18.

The tension roller 12 is disposed right after the holder 8 of the conveyer 10, and controls so as not to have any slack in the roll paper 3 that is fed from the holder 8. The tension roller 12 is disposed so as to be movable in a vertical direction, and moves downwardly in the vertical direction due to force, such as a self-weight or a spring, to apply back tension to the roll paper 3 that is being conveyed. By the function of such a tension roller 12, constant tension (tension) applied to the roll paper 3 is maintained, thereby stabilizing the conveyance of the roll paper 3.

The follower roller 13 is a roller which rotates, in conjunction with the roll paper 3 being conveyed, around the positionally-fixed rotating shaft. The follower roller 13 is disposed at the downstream side relative to the tension roller 12 in a conveying route, and serves to adjust a conveying direction of the roll paper 3.

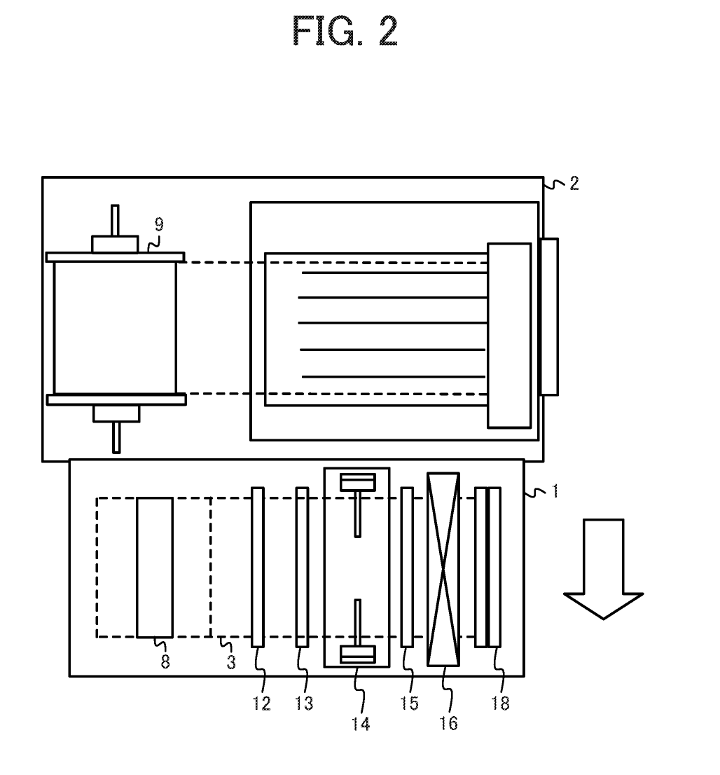

The paper setup unit 14 is a unit prepared for an operator to set paper. More specifically, as illustrated in FIG. 2, the interior of the paper feeding device 1 can be pulled out in the direction along an arrow in the figure, and the paper setup unit 14 includes a pair of rotatable presser bars.

In the condition illustrated in FIG. 2, the operator tucks, into the paper-feeder conveying roller pair 15, the roll paper 3 wound off from the holder 8, and then presses the roll paper 3 placed on the paper setup unit 14 by the pair of presser bars.

The paper-feeder conveying roller pair 15 is a roller pair to convey, to a subsequent convey mechanism, the roll paper 3 set by the paper setup unit 14. More specifically, the paper-feeder conveying roller pair 15 is driven and controlled by an unillustrated motor, and a clutch that controls transmission of a driving force from the motor.

When the clutch is actuated, the driving force from the motor is transmitted to the rotating shaft, and the paper-feeder conveying roller pair 15 holds the roll paper 3 therebetween, and conveys and supplies the holding part of the roll paper to the guillotine cutter 16 and the turnover guide 17. Conversely, when the clutch is de-actuated, no driving force is transferred to the rotating shaft from the motor, and the paper-feeder conveying roller pair 15 runs idle.

The guillotine cutter 16 is a cutter to cut out the roll paper 3. The guillotine cutter 16 cuts the back end of the roll paper 3 vertically at, for example, an appropriate timing at which the roll paper 3 with a necessary length for image formation by the image forming device 2 has been conveyed. The specific cutting process using the guillotine cutter 16 will be explained later. Note that the guillotine cutter 16 serves as a cutter.

The turnover guide 17 is a guide that changes the conveying direction of the roll paper 3 to the upward direction. In addition, the turnover guide 17 is also a guide that is capable of changing the position in a direction along an arrow in the figure. Various schemes of changing the position of the turnover guide are applicable, but for example, the turnover guide may be rotatably pivoted by an unillustrated shaft, and may be caused to swing around this shaft to change the position. Note that a specific position change timing, and the like will be explained later.

The main-box-entry conveying roller pair 18 is a roller pair which is located at the downstream side relative to the paper-feeder conveying roller pair 15, and feeds the roll paper 3 in the image forming device 2. More specifically, the main-box-entry conveying roller pair 18 is driven and controlled by the motor for the paper-feeder conveying roller pair 15, and a clutch that controls transmission of the driving force from this motor.

When the clutch is actuated, the driving force from the motor is transmitted to the rotating shaft, and the main-box-entry conveying roller pair 18 holds the roll paper 3 therebetween, and conveys and feds the holding part of the roll paper into the interior of the image forming device 2. Conversely, when the clutch is de-actuated, no driving force is transferred to the rotating shaft from the motor, and the main-box-entry conveying roller pair 18 runs idle.
An operation of setting the roll paper 3 will be explained in detail. First, as illustrated in FIG. 2, the operator pulls out the interior of the paper feeding device 1 in the direction along the arrow. Next, after the roll paper 3 is set on the holder 8, the roll paper 3 is drawn out from the holder 8 and is caused to pass through the lower space of the tension roller 12, and to pass through the upper space of the follower roller 13. Subsequently, the operator draws out the roll paper 3 up to the paper setup unit 14, holds the roll paper between the paper-feeder conveying roller pair 15, and, presses the roll paper 3 by the pair of presser bars.

In this condition, when the paper feeding device 1 is closed, the set roll paper 3 is detected by appropriate sensors, and the paper-feeder conveying roller pair 15 rotates and drives. This causes the roll paper 3 to pass through the guillotine cutter 16, be subjected to the direction change by the turnover guide 17, and be fed to the main-box-entry conveying roller pair 18, and, stands by at a home position right before the entry to the image forming device 2.

Conversely, the winder 9 disposed on the paper feeding device 1 is a member that rewinds and holds the roll paper 3 ejected from the image forming device 2. Like the holder 8, the winder 9 includes a rotatable rewinding shaft (a shaft) which passes through the winding center of the roll paper 3, and which holds the roll paper 3, and, a support stage that supports the rewinding shaft. The winder rotatably holds the roll paper 3.

The winder 9 is equipped with an unillustrated motor to rotate the rewinding shaft. The winder 9 rotates, by driving this motor, the rewinding shaft at a number of rotations per an instructed unit time, and rewinds the roll paper 3 fed from the image forming device 2 through a follower roller 19.

Next, the image forming device 2 is a printer main box which is placed and stacked on the paper feeding device 1, and which forms an image on the roll paper 3 fed from the paper feeding device 1. The image forming device 2 serves as, for example, a label printer, and forms a seamless image of image data with a relatively large area on the roll paper 3 continuously fed from the paper feeding device 1.

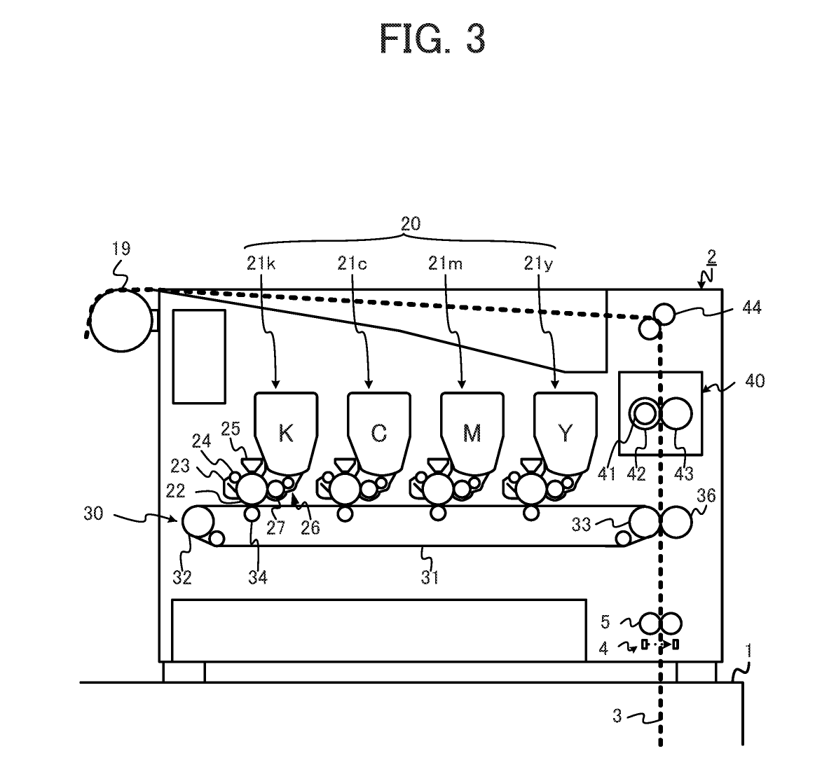

An explanation will be given of an internal structure of the image forming device 2 with reference to FIG. 3. In the following explanation, an electrophographic, secondary-transfer and tandem color printer will be explained as an example image forming device 2. The image forming device 2 includes a paper-front-end detecting sensor 4, a main-box conveying roller pair 5 (first roller pair), an image forming mechanism 20, an intermediate transfer belt unit 30, a fixing device 40, and the like.

The paper-front-end detecting sensor 4 is a sensor to detect the front end of the roll paper fed from the main-box-entry conveying roller pair 18 of the paper feeding device 1. More specifically, the paper-front-end detecting sensor 4 includes a light emitter and a light receiver, and when light emitted by the light emitter is blocked by the front end of the roll paper 3 and the light receiver becomes a condition not detecting the light, the paper-front-end detecting sensor 4 determines that the front end of the roll paper 3 is detected.

The main-box conveying roller pair 5 holds therebetween the roll paper 3 fed by the main-box-entry conveying roller pair 18 of the paper feeding device 1, and conveys the roll paper 3 to a secondary transfer roller 36.

In addition, the main-box conveying roller pair 5 is the first roller pair that first holds the roll paper 3 after the roll paper is fed.

The secondary transfer roller 36 is disposed so as to contact a follower roller 33 with a pressure via a transfer belt 31, and forms a secondary transfer mechanism that performs secondary transfer of a toner image on the belt face of the transfer belt 31 to the roll paper 3.

The image forming mechanism 20 employs a structure in which four image forming units 21 (21k, 21c, 21m, and 21y) are arranged side by side in series. Among the four image forming units 21, the image forming units 21c, 21m, and 21y form a color image with color toners of cyanogen (C), magenta (M), and yellow (Y), respectively. In contrast, the image forming unit 21k forms a black-and-white image with black (K) toners.

Each image forming unit 21 includes a photoreceptor drum 22 at the bottom. This photoreceptor drum 22 has an outer circumference formed of, for example, an organic photoconductive material. Disposed near the photoreceptor drum 22 so as to surround the outer circumference thereof are a cleaner 23, an electrically-charged roller 23, an optical writing head 25, and a developing roller 27 of a developer 26,

The developer 26 includes a toner container which is disposed at an upper part and which contains any of the black (K), cyan (C), magenta (M), and yellow (Y) toners, a toner resupplying mechanism for a lower part disposed at a middle part, and the developing roller 27 disposed at a lower part.

Although reference numerals are given only to the structural members of the image forming unit 21k for black (K) in FIG. 3, each image forming unit 21 employs the same structure except the color of the toner contained in the toner container.

The intermediate transfer belt unit 30 includes, the endless transfer belt 31, a driving roller 32 that runs this transfer belt 31 in a counterclockwise direction, and the follower roller 33. The transfer belt 31 conveys, to a transfer position, a toner image that has been directly transferred (primary transfer) on the belt face in order to transfer (secondary transfer) this toner image to the roll paper 3.

The intermediate transfer belt unit 30 includes four primary transfer rollers 34 corresponding to the four image forming units 21k, 21c, 21m, and 21y. Each primary transfer roller 34 rotates at an instructed rotation cycle, and causes the transfer belt 31 to be in contact with the photoreceptor drum 22, and to be apart from the photoreceptor drum 22.

The fixing device 40 includes a heating roller 42 having a built-in heater 41, and a pressure roller 43 that contacts the heating roller 42 with a pressure. The fixing device 40 heats and applies pressure to unfixed toners on the roll paper 3, thereby to fix the toners after the secondary transfer.

In addition, provided at the downstream side relative to the fixing device 40 is a paper ejecting roller pair 44 that ejects the roll paper 3 having undergone toner fixing from the image forming device 2. The roll paper 3 that has passed through the paper ejecting roller pair 44 is rewound by the winder 9 through a follower roller 19 disposed at the side of the image forming device 2.

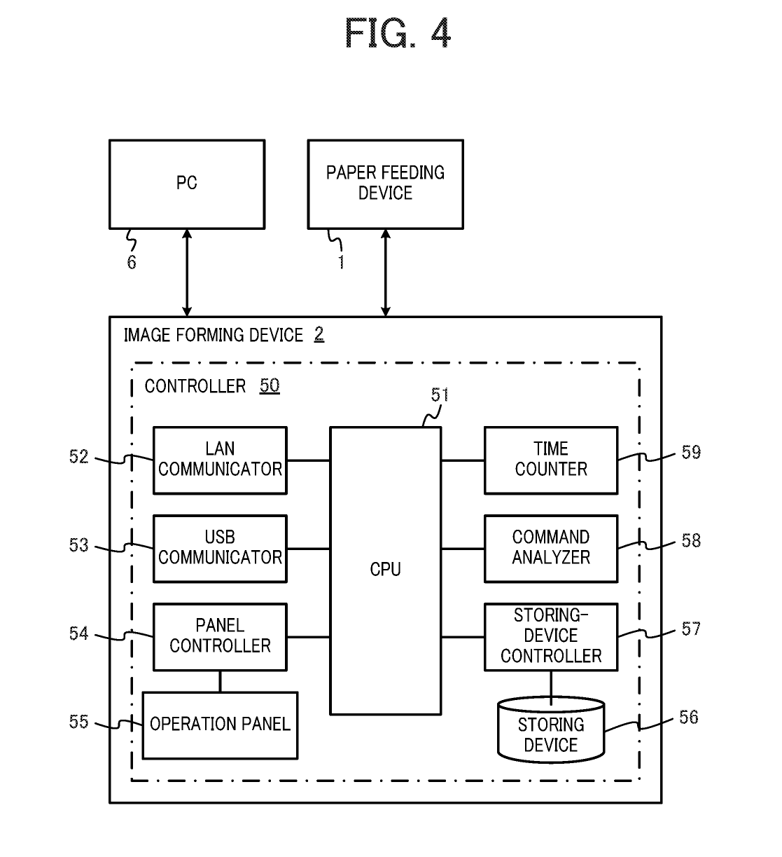

Next, with reference to FIG. 4, a structure with respect to a control of the image forming device 2 will be explained.

The image forming device 2 is connected with a PC 6 and the paper feeding device 1 via a network like a Local Area Network (LAN) or a Universal Serial Bus (USB).

The image forming device 2 includes a controller 50. This controller 50 includes a CPU 51, a LAN communicator 52, a USB communicator 53, a panel controller 54, an operation panel 55, a storing device 56, a storing-device controller 57, a command analyzer 58, and a time counter 59.

The CPU 51 is connected with each component of the image forming device 2 via a system bus that is a transmission route to transfer instructions and data, and controls the operation of each component of the image forming device 2. The CPU 51 reads, while utilizing unillustrated Read Only Memory (ROM) and Random Access Memory (RAM) as work memories, various programs like a system software stored in the ROM or the storing device 56, and executes the read programs as needed.

The LAN communicator 52 and the USB communicator 53 communicate with the external device via the LAN and the USB, respectively. For example, the CPU 51 communicates with the PC 6 and the paper feeding device 1 via the LAN communicator 52 or the USB communicator 53, receives a printing job transmitted from the PC 6, and transmits a conveyance request of the roll paper 3 to the paper feeding device 1.

The panel controller 54 is connected with the operation panel 55 that includes a display panel like a Liquid Crystal Display (LCD), and an input device with various operation buttons. The panel controller 54 displays, under the control of the CPU 51, various images, characters, symbols, and the like on the operation panel 55.

In addition, the panel controller 54 accepts various operations given by the user and input to the operation panel 55, and supplies, to the CPU 51, operation signals corresponding to various accepted operations.

The storing device 56 is a non-volatile memory, such as an Electrically Erasable Programmable ROM (EEPROM) or a Hard Disk Drive (HDD). The storing device 56 stores various programs and various data necessary for the image forming device 2 to operate. The storing device 56 stores, for example, data on a conveying speed when the main-box conveying roller pair 5 of the image forming device 2 conveys the roll paper 3, data on a conveying speed when the paper-feeder conveying roller pair 15 and the main-box-entry conveying roller pair 18 convey the roll paper 3, data on a distance from the paper-front-end detecting sensor 4 to the holding part of the main-box conveying roller pair 5.

The storing-device controller 57 controls, under the control of the CPU 51, writing of data in the storing device 56, and reading of data stored in the storing device 56.

The command analyzer 58 analyzes, under the control of the CPU 51, a command contained in the print data transmitted from the PC 6, and converts the print data into image data in a bitmap format.

The time counter 59 has a function of counting a time by, for example, a clock. When the paper-front-end detecting sensor 4 detects the front end of the roll paper 3, the time counter 59 starts counting a time.

The controller 50 of the image forming device 2 employing the above respective functions controls a printing mechanism that includes the image forming mechanism 20, the intermediate transfer belt unit 30, the fixing device 40, and the like, as needed, and performs an image forming process according to bitmap image data created by the command analyzer 58. For example, the controller 50 performs drive control on the transfer belt 3, timing control of the primary transfer and the secondary transfer, and drive control on the main-box conveying roller pair 5.

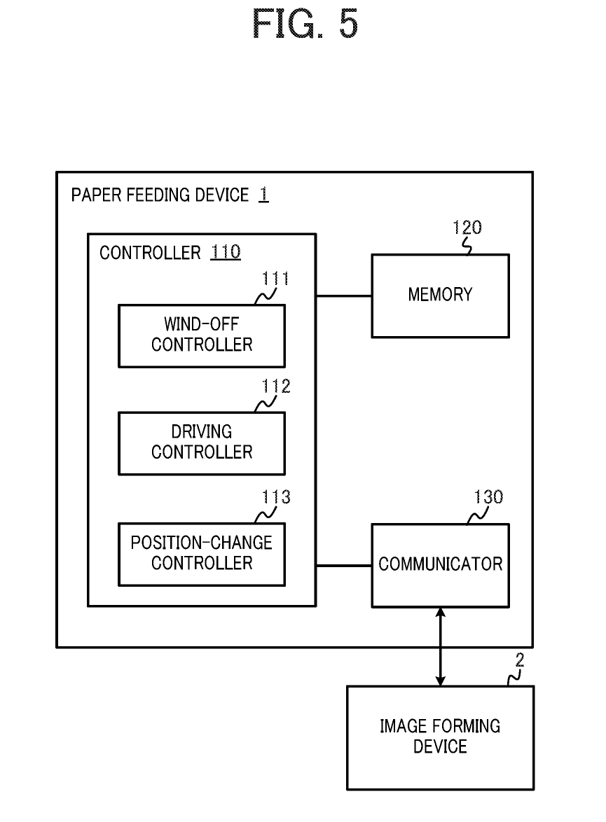

Next, with reference to FIG. 5, an explanation will be given of a structure with respect to a control of the paper feeding device 1. The paper feeding device 1 includes a controller 110, a memory 120, and a communicator 130.

The controller 110 includes, for example, a CPU, and a RAM that serves as a main memory for the CPU. The controller 110 is connected with each component of the paper feeding device 1 via a system bus that is a transmission path to transmit instructions and data, and controls the entire paper feeding device 1. Note that the controller 110 may partially include a special-purpose circuit like an Application Specific Integrated Circuit (ASIC).

The memory 120 is, for example, a memory device, such as a ROM or a flash memory. The memory 120 stores various programs and various data utilized by the controller 110 to execute various processes. For example, the memory 120 stores a program for a cutting process of the roll paper to be explained later, and data on a conveying speed of the roll paper 3 when a conveyance request of the roll paper 3 is received from the image forming device 2.

The communicator 130 communicates with the image forming device 2 connected via the LAN, the USB, or the like, under the control of the controller 110. For example, the communicator 140 receives a conveyance request of the roll paper 3 transmitted from the image forming device 2, and receives information which indicates that the roll paper 3 has been held, and which is transmitted from the image forming device 2. Note that the communicator 130 serves as a receiver.

In this case, the controller 110 includes a wind-off controller 111, a driving controller 112 (controller), and a position-change controller 113.

The wind-off controller 111 controls the wind-off operation of the roll paper 3 from the holder 8. More specifically, the wind-off controller 111 intermittently drives the rotating shaft of the holder 8, and winds off the roll paper 3 while controlling the amount of slack of the roll paper 3.

The driving controller 112 controls the conveyance of the roll paper 3 wound off from the holder 8 by the wind-off controller 111. More specifically, the driving controller 112 controls, via the motor and the clutches, the driving operation of the controllable roller pairs (that is, paper-feeder conveying roller pair 15 and main-box-entry conveying roller pair 18) in the conveyer 10 so as to convey the roll paper 3 at a predetermined conveying speed.

The position-change controller 113 controls the position change of the turnover guide 17. More specifically, the position-change controller 113 changes the position of the turnover guide 17 prior to the cutting process of the roll paper 3 to be executed by the guillotine cutter 16 so as to ensure a space for allowing the roll paper 3 to have a slack.

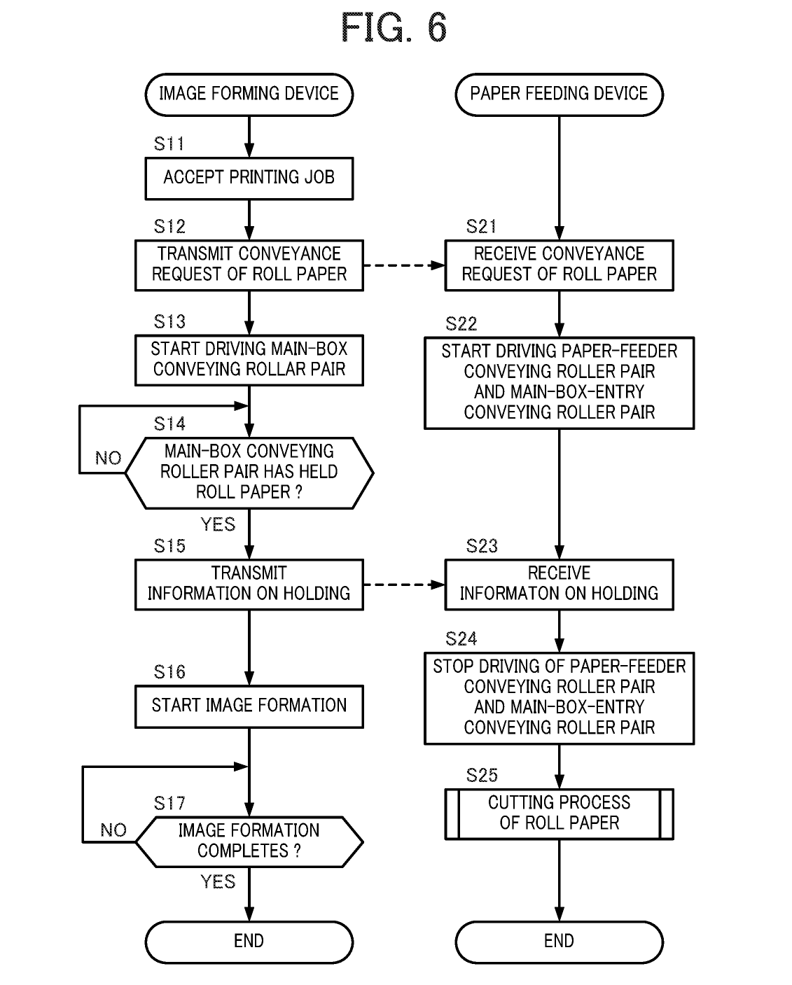

For example, a feature of the printing device 100 explained with reference to FIG. 1 to FIG. 5 is that the paper-feeder conveying roller pair 15 and the main-box-entry conveying roller pair 18 in the paper feeding device 1, and the main-box conveying roller pair 5 in the image forming device 2 are driven and controlled so as to prevent the roll paper 3 from running obliquely. Hence, the process flow of the image forming device 2 and the paper feeding device 1 relating to this feature will be explained below with reference to the flowchart of FIG. 6.

With the roll paper 3 being in the home position of the paper feeding device 1, it is assumed that the user gives a printing start instruction with the operation panel 55 or the PC 6. Upon receiving (S11) a printing job relating to the printing start instruction by the controller 50 of the image forming device 2, the process in the flowchart of FIG. 6 starts.

More specifically, when the user gives the printing start instruction with the PC 6, the controller 50 receives, via the LAN communicator 52 or the USB communicator 53, the printing job that contains print data, a printing setup condition, and the like transmitted from the PC 6. The controller 50 analyzes the received printing job with the command analyzer 58, generates bitmap image data from the print data contained in the printing job, and obtains, from the printing setup condition, information on the setup condition necessary for image formation.

Next, the controller 50 transmits (S12) the conveyance request of the roll paper 3 to the paper feeding device 1. More specifically, the controller 50 transmits, to the paper feeding device 1 via the LAN communicator 52 or the USB communicator 53, a request of feeding the roll paper 3 to execute the image formation.

This conveyance request also contains information on the necessary length of the roll paper 3 for the image formation. That is, the controller 50 calculates the necessary length of the roll paper 3 for the image formation based on the area of the image data created from the received print data, and transmits the conveyance request that contains the calculated length of the roll paper 3 to the paper feeding device 1.

Next, the communicator 130 of the paper feeding device 1 receives (S21) the conveyance request of the roll paper 3.

Subsequently, the driving controller 112 of the paper feeding device 1 starts driving (S22) the paper-feeder conveying roller pair 15 and the main-box-entry conveying roller pair 18. More specifically, the driving controller 112 drives the common motor to the paper-feeder conveying roller pair 15 and the main-box-entry conveying roller pair 18 in such a way that the roll paper 3 is conveyed at a conveying speed V1 (second conveying speed), and actuates the respective clutches. Hence, conveyance of the roll paper 3 starts at the conveying speed V1 from the home position toward the image forming device 2.

Note that the driving controller 112 may read the conveying speed V1 from the memory 120, or when the printing job contains data on the conveying speed V1, the driving controller may read from the printing job.

Conversely, the controller 50 of the image forming device 2 starts driving (S13) the main-box conveying roller pair 5 at the same timing as S22. More specifically, the controller 50 drives the motor for the main-box conveying roller pair 5 beforehand so as to convey the roll paper 3 at a conveying speed V2 (first conveying speed) that is faster than the conveying speed V1. This enables the main-box conveying roller pair 5 to stand by while being rotated and driven during the conveyance of the roll paper 3 toward the holding part of the main-box-entry conveying roller pair 5.

In order to start driving the main-box conveying roller pair 5 at the same timing as S22, for example, the controller 50 may receive a notification of a driving start timing from the paper feeding device 1 that has received the conveyance request, or may set, with the paper feeding device 1 beforehand, a time after the conveyance request is received and until the drive starts, and synchronize the driving start. In addition, the controller 50 may read the conveying speed V2 from the recording device 56, or when the printing job contains data on the conveying speed V2, the controller may read from the printing job.

Next, the controller 50 of the image forming device 1 determines (S14) whether or not the main-box conveying roller pair 5 has held the roll paper 3. More specifically, the controller 50 determines whether or not the roll paper 3 has been held using the paper-front-end detecting sensor 4, the data on the conveying speed V1 of the roll paper 3 stored in the storing device 56, the data on the distance from the paper-front-end detecting sensor 4 to the holding part of the main-box conveying roller pair 5, and the time counter 59.

Further more specifically, the controller 50 calculates, based on the data on the conveying speed V1 and the data on the distance beforehand, the number of seconds until the roll paper 3 reaches the holding part, and when the paper-front-end detecting sensor 4 detects the front end of the roll paper 3, causes the time counter 59 to start counting the time. When the above number of seconds has elapsed, the controller determines that the main-box conveying roller pair 5 has held. Conversely, until the above number of seconds elapses, the controller 50 determines that the main-box conveying roller pair 5 has not held yet. Note that the controller 50 serves as a determiner.

In this case, the controller 50 executes a standby process (S14: NO) until the main-box conveying roller pair 5 holds the roll paper 3, and when determining (S14: YES) that the main-box conveying roller pair 5 has held the roll paper 3, the controller transmits (S15), to the paper feeding device 1, information indicating that the roll paper has been held.

Next, when the communicator 130 of the paper feeding device 1 receives (S23) the information indicating that the roll paper has been held, the driving controller 112 stops driving (S24) of the paper-feeder conveying roller pair 15 and the main-box-entry conveying roller pair 18. More specifically, the driving controller 112 de-actuates the respective clutches of the paper-feeder conveying roller pair 15 and the main-box-entry conveying roller pair 18. Hence, no driving force is transmitted to the respective rotating shafts of both rollers from the motor, and both rollers start running idle in accordance with the conveying speed V2 by the main-box conveying roller pair 5.

Conversely, the controller 50 of the image forming device 2 conveys the roll paper 3 toward the secondary transfer mechanism at the conveying speed V2 after the main-box conveying roller pair 5 holds the roll paper 3, and starts (S16) image formation. More specifically, the controller 50 controls the image forming mechanism 20 and the intermediate transfer belt unit 30 as needed while conveying the roll paper 3 at the conveying speed V2, and starts image formation according to the bitmap image data. The controller 50 keeps performing image formation (S17: NO) until images of all image data are formed on the roll paper 3.

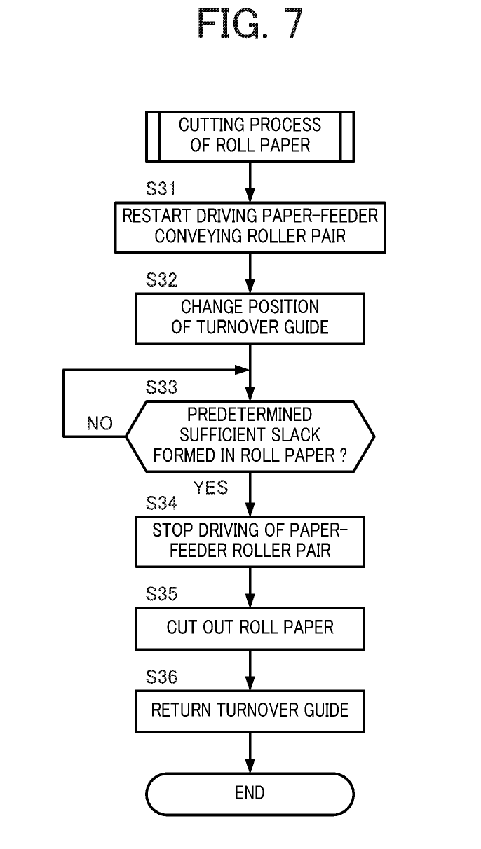

Conversely, the paper feeding device 1 executes (S25) the cutting process of the roll paper at an appropriate timing between the start of the image formation by the image forming device 2 and the end of the image formation. More specifically, based on the necessary length of the roll paper 3 for the image formation which is contained in the received conveyance request, the paper feeding device 1 starts the cutting process of the roll paper at an appropriate timing. In this case, an explanation will be given of the cutting process of the roll paper with reference to FIG. 7.

First, the driving controller 112 of the paper feeding device 1 restarts (S31) driving of the paper-feeder conveying roller pair 15. More specifically, the driving controller 112 changes the operation status of the clutch of the paper-feeder conveying roller pair 15 from the de-actuated status to the actuated status to transmit the driving force of the motor to the rotating shaft again, while at the same time, increases the rotating speed of the motor in such a way that the conveying speed of the roll paper 3 becomes a conveying speed V3 (third conveying speed) that is faster than the conveying speed V2. This increases the conveying speed by the paper-feeder conveying roller pair 15, and thus a formation of a slack between the guillotine cutter 16 and the main-box-entry conveying roller pair 18 starts.

Next, the position-change controller 113 of the paper feeding device 1 changes (S32) the position of the turnover guide 17. More specifically, the position-change controller 113 changes the position of the turnover guide 117 in the direction along the arrow in FIG. 1 so as to ensure, on the conveying route, a space to form a slack. Hence, the turnover guide 17 is located at the position indicated by a chain line in FIG. 1. Note that the process in this step S32 may be executed simultaneously with the process in the step S31.

Next, the controller 110 of the paper feeding device 1 determines (S33) whether or not a sufficient slack is formed in the roll paper 3. As for whether or not a sufficient slack is formed, for example, a sensor that detects the sufficient slack may be applied, or a time to form the sufficient slack may be obtained beforehand by a test or the like, and whether or not such a time has elapsed may be determined. The controller 110 determines whether or not the sufficient slack is formed by those arbitrary schemes.

The driving controller stands by (S33: NO) until the sufficient slack is formed in the roll paper 3, and when the sufficient slack is formed (S33: YES), the driving controller 112 stops driving (S34) of the paper-feeder conveying roller pair 15. More specifically, the driving controller 112 changes the operation status of the clutch of the paper-feeder conveying roller pair 15 from the actuated status to the de-actuated status so as to transmit no diving force of the motor to the rotating shaft. This causes the roll paper 3 right below the guillotine cutter 16 to be stopped until the formed slack is pulled by the main-box conveying roller 5 at the conveying speed V2 and eliminated.

Next, the controller 110 of the paper feeding device 1 controls the guillotine cutter 16 to cut out (S35) the roll paper 3. More specifically, the controller 110 cuts out the roll paper 3 using the guillotine cutter 16 after the formed slack is eliminated and before the roll paper 3 is conveyed again at the conveying speed V2.

Subsequently, the position-change controller 113 of the paper feeding device 1 returns (S36) the turnover guide 17, and ends the cutting process of the roll paper. More specifically, the position-change controller 113 returns the turnover guide 17 to the position indicated by a thick line in FIG. 1, and ends the cutting process of the roll paper. Together with the end of the cutting process of the roll paper, the process by the paper feeding device 1 in the image formation also ends (see FIG. 6).

Conversely, when the controller 50 of the image forming device 2 performs image formation up to the vicinity of the back end of the cut roll paper 3, and completes (S17: YES) image formation of all image data, the controller ends the process. Subsequently, through the fixing process by the fixer 40, the roll paper 3 is rewound by the winder 9.

In the above processes in FIG. 6, the image forming device 2 transmits, to the paper feeding device 1, the information indicating that the main-box conveying roller pair 5 has held the roll paper 3 fed by the main-box-entry conveying roller pair 18, and the paper feeding device 1 that has received this information stops driving of the paper-feeder conveying roller pair 15 and that of the main-box-entry conveying roller pair 18.

This causes the paper-feeder conveying roller pair 15 and the main-box-entry conveying roller pair 18 to run idle, enabling the image forming device 1 to control the conveyance of the roll paper 3. Hence, in comparison with conventional technologies that form a certain amount of slack in image formation, no slack is formed in the roll paper 3. Since the slack that is a cause of oblique running is eliminated, in the conveyance of the roll paper, an oblique running is preventable.

In addition, after the main-box conveying roller pair 5 of the image forming device 2 has held the roll paper 3, the image forming device 2 becomes able to control the conveyance of the roll paper 3. Hence, a fine control to the conveying speed V2 is enabled, allowing the secondary transfer mechanism to precisely form an image.

Still further, according to the above processes in FIG. 6, in order to suppress an oblique running, an additional mechanical oblique running correcting mechanism is unnecessary. Since the number of components does not increase, an oblique running is correctable without increasing the manufacturing costs.

Yet still further, according to the above processes in FIG. 6, the conveying speed V2 of the roll paper 3 by the main-box conveying roller pair 5 is faster than the conveying speed V1 of the roll paper 3 by the paper-feeder conveying roller pair 15 and the main-box-entry conveying roller pair 18 until the roll paper 3 is held by the main-box conveying roller pair 5. Accordingly, no slack is formed in the roll paper 3 at the moment when the main-box conveying roller pair 5 holds the roll paper 3. Hence, in the conveyance of the roll paper, an oblique running is further preventable.

Moreover, according to the processes in FIG. 7, before the guillotine cutter 16 cuts out the roll paper 3, the driving of the paper-feeder conveying roller pair 15 is restarted in such a way that the conveying speed V3 of the roll paper 3 by the paper-feeder conveying roller pair 15 becomes faster than the conveying speed V2 of the roll paper 3 by the main-box conveying roller pair 5. This enables a formation of a slack between the guillotine cutter 16 and the main-box-entry conveying roller 18. Hence, the conveyance of the roller paper 3 right below the guillotine cutter 16 can be stopped while absorbing, by the formed slack, the conveyance of the roll paper 3 by the main-box conveying roller 5. Therefore, without giving an adverse effect to the image forming device 2, that is, without stopping the conveyance of the roll paper 3, the roll paper 3 can be precisely cut out.

In addition, according to the processes in FIG. 7, when the driving controller 112 restarts the driving of the paper-feeder conveying roller pair 15, the position-change controller 113 changes the position of the turnover guide 17. This ensures the space to form the slack. Therefore, in comparison with a case in which the slack is formed by only the paper-feeder conveying roller pair 15, the time for forming the slack can be reduced.

Still further, according to this embodiment, the roll paper 3 is cut out by the guillotine cutter 16. In general, even in the case of a roll paper, depending on the paper type, the conveying speed should be changed. Hence, the guillotine cutter 16 is more suitable than a rotary cutter that is provided in accordance with a single conveying speed.

### Modified Example

The explanation for the embodiment ends above, but the above embodiment is merely an example, and needless to say, the specific structure, process detail, and the like of the printing device 100, the paper feeding device 1, and the image forming device 2 are not limited to the above explained embodiment.

For example, in the above embodiment, the paper-feeder conveying roller pair 15 and the main-box-entry conveying roller pair 18 are both controlled by the motor and the clutches, but the present disclosure is not limited to this structure. Such roller pairs may be controlled via any members as long as (1) drive control (actuated or de-actuated) to change rotating operation/running idle operation of both roller pairs, (2) speed change of the paper-feeder conveying roller pair 15 to form the slack are realizable.

In addition, according to the above embodiment, the clutches are applied to perform drive control for actuation or de-actuation of the paper-feeder conveying roller pair 15 and the main-box-entry conveying roller pair 18, but those clutches may be various clutches. For example, an electro-magnetic clutch, a directional clutch, and the like, are applicable.

Still further, according to the above embodiment, the controller 50 determines, using the paper-front-end detecting sensor 4, whether or not the main-box conveying roller pair 5 has held the roll paper 3, but the present disclosure is not limited to this structure. Any scheme is applicable as long as at least such a scheme is capable of determining that the main-box conveying roller pair 5 has held the roll paper 3. The holding determination may be performed by, for example, a holding determination sensor which directly determines that the roll paper 3 has been held or other conventionally well-known schemes.

Yet still further, the above embodiment is based on an assumption that the printing device 100 has the image forming device 2 placed and stacked on the paper feeding device 1 (that is, the image forming device 2 and the paper feeding device 1 are separate devices), but the present disclosure is not limited to this structure. For example, the printing device 100 may include, as integral mechanisms, an image forming mechanism corresponding to the image forming device 2, and a paper feeding mechanism corresponding to the paper feeding device 1.

In this case, when the drive source for the rollers in the image forming mechanism and the drive source for the rollers in the paper feeding mechanism are different, that is, when those rollers are driven and controlled by separate motors, the similar technical problem occurs. Hence, the above processes in FIG. 6 and in FIG. 7 are still applicable to the integral structure. However, since this is an integral structure, transmitting/receiving processes (S12 and S21, S15 and S23) performed in the processes in FIG. 6 and in FIG. 7 between the image forming device 2 and the paper feeding device 1 may be omitted. When, for example, in the case of an integral structure, a determination that the main-box conveying roller pair 5 has held the roll paper 3 is made, the transmitting/receiving processes of the information indicating the holding operation may be omitted, and the driving of the paper-feeder conveying roller pair 15 and that of the main-box-entry conveying roller pair 18 may be stopped.

Yet still further, according to the above embodiment, the image forming device 2 is an electrophographic, secondary-transfer and tandem color printer. However, the paper feeding device 1 of the present disclosure may be connected with all other image forming devices that perform image formation, such as printers, copiers, and facsimiles, in other forms to execute the above processes.

Moreover, each function of the paper feeding device 1 of the present disclosure (for example, drive control of the paper-feeder conveying roller pair 15 and the main-box-entry conveying roller pair 18, a position-change control of the turnover guide 17, and the like) may be realized by a computer like a normal PC.

More specifically, according to the above embodiment, the program for the paper feeding device 1 is stored in the memory 120 beforehand. However, this program may be installed in a computer to construct a computer capable of executing the respective above functions. Note that the program may be stored in not only the memory 120 but also other non-transitory computer-readable recording media (such as a flexible disk, a CD-ROM, a DVD and an MO), and may be distributed for computers.

In addition, the program may be stored in a disk device or the like of a server device over a communication network like the Internet, and may be, for example, downloaded to a computer.

Preferred embodiments of the present disclosure were explained above, but the present disclosure is not limited to such specific embodiments, and covers the invention as recited in appended claims and the equivalent range thereto.

This application claims a priority based on Japanese Patent Application No. 2013-189713 filed on Sep. 12, 2013, the entire contents of which are herein incorporated in this application by reference.

1. A printing device comprising:
an image former performing an image formation on a recording medium in a rolled shape, and including a first roller pair that rotates to convey the recording medium in the rolled shape; and
a supplier comprising a second roller pair that rotates to convey the wound-off recording medium in the rolled shape to the image former, and a controller that actively rotates the second roller pair,
wherein:
the image former comprises a determiner that determines whether or not the first roller pair that conveys the recording medium in the rolled shape conveyed from the second roller pair has held the recording medium in the rolled shape; and
when the determiner determines that the recording medium in the rolled shape has been held, the controller stops the active rotation of the second roller pair.

2. The printing device according to claim 1, wherein the first roller pair is a roller pair that first holds the recording medium in the rolled shape after the recording medium in the rolled shape is conveyed, and conveys the recording medium in the rolled shape by an active rotation after holding the recording medium in the rolled shape, the recording medium being conveyed from the second roller pair.

3. The printing device according to claim 1, wherein a first conveying speed by an active rotation of the first roller pair is faster than a second conveying speed by the active rotation of the second roller pair until the recording medium in the rolled shape is held by the first roller pair.

4. The printing device according to claim 3, wherein:
the supplier comprises a third roller pair that rotates to convey the recording medium in the rolled shape located at an upstream side relative to the second roller pair, and, a cutter located between the third roller pair and the second roller pair and cutting out the recording medium in the rolled shape; and
when the determiner determines that the recording medium in the rolled shape has been held, the controller stops an active rotation of the third roller pair, and restarts, before the cutter cuts out the recording medium in the rolled shape, the active rotation of the third roller pair in such a way that a third conveying speed of the recording medium in the rolled shape by the third roller pair becomes faster than the first conveying speed of the recording medium in the rolled shape by the first roller pair to form a slack in the recording medium in the rolled shape between the cutter and the second roller pair.

5. The printing device according to claim 4, wherein:
the supplier comprises a guide for the recording medium in the rolled shape, the guide being located between the cutter and the second roller pair and being capable of changing a position, and, a position-change controller that controls the position change of the guide; and
the position-change controller changes the position of the guide when the controller restarts the active rotation of the third roller pair.

6. The printing device according to claim 4, wherein the cutter comprises a guillotine cutter.

7. A supply device comprising:
a controller that actively rotates a second roller pair which rotates to convey a wound-off recording medium in a rolled shape to an image forming device; and
a determiner that determines whether or not a first roller pair of the image forming device has held the recording medium in the rolled shape, the first roller pair rotating to convey the recording medium in the rolled shape, and the recording medium being conveyed from the second roller pair,
wherein when the determiner determines that the recording medium in the rolled shape has been held, the controller stops the active rotation of the second roller pair.

8. The supply device according to claim 7, wherein the first roller pair is a roller pair that first holds the recording medium in the rolled shape after the recording medium in the rolled shape is conveyed, and conveys the recording medium in the rolled shape by an active rotation after holding the recording medium in the rolled shape, the recording medium being conveyed from the second roller pair.

9. The supply device according to claim 7, wherein a first conveying speed by an active rotation of the first roller pair is faster than a second conveying speed by the active rotation of the second roller pair until the recording medium in the rolled shape is held by the first roller pair.

10. The supply device according to claim 9, further comprising:
a third roller pair that rotates to convey the recording medium in the rolled shape located at an upstream side relative to the second roller pair; and
a cutter located between the third roller pair and the second roller pair and cutting out the recording medium in the rolled shape,
wherein when the determiner determines that the recording medium in the rolled shape has been held, the controller stops an active rotation of the third roller pair, and restarts, before the cutter cuts out the recording medium in the rolled shape, the active rotation of the third roller pair in such a way that a third conveying speed of the recording medium in the rolled shape by the third roller pair becomes faster than the first conveying speed of the recording medium in the rolled shape by the first roller pair to form a slack in the recording medium in the rolled shape between the cutter and the second roller pair.

11. The supply device according to claim 10, further comprising a guide for the recording medium in the rolled shape, the guide being located between the cutter and the second roller pair and being capable of changing a position, and, a position-change controller that controls the position change of the guide,
wherein the position-change controller changes the position of the guide when the controller restarts the active rotation of the third roller pair.

12. The supply device according to claim 10, wherein the cutter comprises a guillotine cutter.

13. A roller control method comprising:
a controlling step of actively rotating a second roller pair that rotates to convey a wound-off recording medium in a rolled shape to an image forming device; and
a determining step of determining whether or not a first roller pair of the image forming device has held the recording medium in the rolled shape, the first roller pair rotating to convey the recording medium in the rolled shape, and the recording medium being conveyed from the second roller pair,
wherein when, in the determining step, the recording medium in the rolled shape is determined as being held by the first roller pair, the active rotation of the second roller pair is stopped.

14. The roller control method according to claim 13, wherein the first roller pair is a roller pair that first holds the recording medium in the rolled shape after the recording medium in the rolled shape is conveyed, and conveys the recording medium in the rolled shape by an active rotation after holding the recording medium in the rolled shape, the recording medium being conveyed from the second roller pair.

15. The roller control method according to claim 13, wherein a first conveying speed by an active rotation of the first roller pair is faster than a second conveying speed by the active rotation of the second roller pair until the recording medium in the rolled shape is held by the first roller pair.

16. The roller control method according to claim 15, further comprising:
a third roller pair that rotates to convey the recording medium in the rolled shape located at an upstream side relative to the second roller pair; and
a cutter located between the third roller pair and the second roller pair and cutting out the recording medium in the rolled shape,
wherein when the determiner determines that the recording medium in the rolled shape has been held, the controller stops an active rotation of the third roller pair, and restarts, before the cutter cuts out the recording medium in the rolled shape, the active rotation of the third roller pair in such a way that a third conveying speed of the recording medium in the rolled shape by the third roller pair becomes faster than the first conveying speed of the recording medium in the rolled shape by the first roller pair to form a slack in the recording medium in the rolled shape between the cutter and the second roller pair.

17. A program causing a computer to function as:
a controller that actively rotates a second roller pair which rotates to convey a wound-off recording medium in a rolled shape to an image forming device; and
a determiner that determines whether or not a first roller pair of the image forming device has held the recording medium in the rolled shape, the first roller pair rotating to convey the recording medium in the rolled shape, and the recording medium being conveyed from the second roller pair,
wherein when the determiner determines that the recording medium in the rolled shape has been held, the controller stops the active rotation of the second roller pair.

18. The program according to claim 17, wherein the first roller pair is a roller pair that first holds the recording medium in the rolled shape after the recording medium in the rolled shape is conveyed, and conveys the recording medium in the rolled shape by an active rotation after holding the recording medium in the rolled shape, the recording medium being conveyed from the second roller pair.

19. The program according to claim 17 making a setting in such a way that a first conveying speed by an active rotation of the first roller pair is faster than a second conveying speed by the active rotation of the second roller pair until the recording medium in the rolled shape is held by the first roller pair.

20. The program according to claim 19, further comprising:
a third roller pair that rotates to convey the recording medium in the rolled shape located at an upstream side relative to the second roller pair; and
a cutter located between the third roller pair and the second roller pair and cutting out the recording medium in the rolled shape,
wherein when the determiner determines that the recording medium in the rolled shape has been held, the controller stops an active rotation of the third roller pair, and restarts, before the cutter cuts out the recording medium in the rolled shape, the active rotation of the third roller pair in such a way that a third conveying speed of the recording medium in the rolled shape by the third roller pair becomes faster than the first conveying speed of the recording medium in the rolled shape by the first roller pair to form a slack in the recording medium in the rolled shape between the cutter and the second roller pair.
